(19) United States
(12) Patent Application Publication
(10) Pub. No.: US 2016/0326939 A1
(43) Pub. Date: Nov. 10, 2016

(54) AN INTERNAL COMBUSTION ENGINE FASTENING ARRANGEMENT, METHOD AND COMPONENT

(71) Applicant: AB VOLVO PENTA, Göteborg (SE)

(72) Inventor: Dan PERSSON, Kungälv (SE)

(73) Assignee: AB VOLVO PENTA, Göteborg (SE)

(21) Appl. No.: 15/103,858

(22) PCT Filed: Dec. 13, 2013
(86) PCT No.: PCT/SE2013/000193

§ 371 Date: Jun. 11, 2016

(51) Int. Cl. F01N 13/18; F02B 39/00; F01N 13/10; F02B 33/40; F02B 37/00

(52) U.S. Cl. CPC F01N 13/1805; F02B 33/40; F02B 37/00; F01N 13/10; F02B 39/00

(57) ABSTRACT

An internal combustion engine arrangement for fastening a first component to a second component includes the first component, the second component and a clamping device for clamping the first and second components together. One of the first and second component includes a recess and the other of the first and second component includes a projection, wherein the recess and projection are configured for being engaged. The clamping device includes a clamping element, which is movably arranged in relation to the first and the second component when in an engaged state. Further, each one of the first and second component includes a flange portion at a distance from the recess and projection, respectively, that the clamping element includes a first and second clamping surface facing each other for effecting an outside of the respective flange portion for clamping the flange portions between the clamping surfaces.

### BACKGROUND AND SUMMARY

The invention relates to an internal combustion engine fastening arrangement.

The fastening arrangement can be used in association with any type of internal combustion engine. Further, the fastening arrangement can be applied in an internal combustion engine arranged for propulsion of a vehicle or vessel. For example, the fastening arrangement can be applied in a marine application, such as in an internal combustion engine arranged for propulsion of a boat. Further, the fastening arrangement can be applied in an internal combustion engine arranged for propulsion of a heavy-duty vehicle, such as a truck, bus or working machines within the fields of industrial construction machines or construction equipment (such as a wheel loaders, articulated hauler or excavator). Although the invention will be described with respect to an internal combustion engine arranged for propulsion of a boat, the invention is not restricted to this particular vessel, but for example may also be used in vehicles such as trucks, buses and working machines.

One application of the internal combustion engine fastening arrangement is for fastening a turbocharger to an exhaust manifold of the internal combustion engine. The exhaust manifold is configured to receive exhaust gases from the engine cylinders and convey the exhaust gases to the turbocharger. The exhaust manifold comprises a substantially vertically oriented engagement surface configured for being in engagement with a correspondingly shaped engagement surface of the turbocharger. The engagement surfaces define an engagement plane for conveying the exhaust gases from a gas channel in the exhaust manifold to a gas channel in the turbocharger. Further, the turbocharger comprises a rectangular flange extending around a gas channel opening in the engagement plane. Further a sealing arrangement is provided between the turbocharger and the exhaust manifold. According to a traditional solution, the rectangular flange is provided with four screw holes, one in each corner of the rectangle, wherein the screw holes are directed perpendicular in relation to the engagement plane. The exhaust manifold is provided with four corresponding threaded screw holes, which are threaded, and positioned for register with the flange screw holes. Four screws are used for fastening the turbocharger to the exhaust manifold via the screw holes. In many internal combustion engine applications, the space for accessing the screws for screwing/unscrewing is limited, which makes the mounting cumbersome. Further, due to a transient heat load during internal combustion engine operation, this type of arrangement may leak due to bulging of a longer side in the rectangular flange.

DE 10 2008 060 028 discloses an alternative solution to the traditional solution described above. An elongated fastening element with an undercut is rigidly attached to the exhaust manifold via two spaced screws at a distance from and above the gas channel opening for receiving a correspondingly shaped elongated, upper flange of the turbocharger. The turbocharger has a further, lower flange opposite the upper flange relative to the gas channel opening. The lower flange is provided with two spaced openings for receipt of two screws with a direction perpendicular to an engagement plane. Further, the elongated fastening element is provided with two spaced openings for receipt of two screws with a direction in parallel with the vertically oriented engagement plane. One problem is that in some internal combustion engine applications, the space for accessing the two screws with a direction perpendicular to the engagement plane is limited which makes the mounting cumbersome. A further problem is still the tendency of the turbocharger flange to bulge at the side opposite the elongated fastening element, potentially leading to leakage.

It is desirable to provide an arrangement, which creates conditions for a facilitated and thereby time-efficient mounting of the two internal combustion engine components.

According to an aspect of the present invention, an internal combustion engine arrangement for fastening a first component to a second component is provided. The fastening arrangement comprises the first component, the second component and a clamping device for clamping the first and second components together. One of the first and second component comprises a recess and the other of the first and second component comprises a projection. The recess and projection are configured for being engaged, wherein the clamping device comprises a clamping element, which is movably arranged in relation to the first and the second component when in an engaged state. Each one of the first and second component comprises a flange portion at a distance from the recess and projection, respectively. The clamping element comprises a first and second clamping surface facing each other for effecting an outside of the respective flange portion for clamping the flange portions between the clamping surfaces.

The provision of the clamping element for clamping the flange portions at a distance from the recess and projection creates conditions for a clamping operation from one side only, namely the side of the clamping element, while the projection is received in the recess.

The term “flange portion” comprises for example an elongated wall configured to form a means for attachment to a neighbouring component. Such an elongated wall may for example be straight. Further, such an elongated wall may for example have a substantially constant cross section along its longitudinal direction.

Further, the provision of flange portions on both the first and second component and a clamping element effecting an outside of both flange portions creates conditions for forcing the projection into the recess during clamping of the two flanges via the clamping element. This type of clamping secures an increased contact pressure between the two components and thereby reduced leakage risk during operation in case the two components are configured for transporting a gas/fluid.

The fastening arrangement is particularly advantageous in regions of high heat load and especially in transient heat load operations since it creates conditions for a tight fit between the two components along substantial parts thereof.

According to one embodiment, the first and second clamping surfaces are inclined in relation to each other. Such a design of the clamping element creates conditions for an improved clamping effect. Especially, the clamping surfaces are inclined in opposite directions so that they form a tapering structure. The clamping surfaces are preferably inclined so that the clamping surface ends (preferably forming free edges of the clamping element) are at a larger distance from each other than an opposite end of the clamping surfaces forming an entrance for receipt of the flange portions. For example, the clamping surfaces extend in substantially straight planes at least along a substantial part thereof. However, the clamping surfaces may alternatively have a somewhat curved shape.

Preferably, the corresponding contact surfaces of the respective flange have a shape commensurate with the clamping surfaces of the clamping element for a good clamping effect.

According to another embodiment, the clamping element comprises two spaced walls, that one of the spaced walls comprises the first clamping surface and the other of the spaced walls comprises the second clamping surface and that the free edges of the spaced walls define an entrance for receipt of the flange portions. This design creates conditions for achieving the required clamping effect by means of a relatively compact clamping element.

According to another embodiment, the clamping element is a one-piece unit. This design creates conditions for achieving the required clamping effect by means of a relatively compact clamping element, which may be cost-effective in production. Preferably, the clamping element comprises a connection portion bridging the distance between the spaced walls. Especially, the clamping element may be elongated and configured with the same cross sectional shape along a substantial portion of the complete length thereof.

According to another embodiment, the clamping device is configured for fbrcing the projection from an initial engagement position further into the recess during assembly of the arrangement. For example, the clamping element is designed and arranged for creating a further relative movement between the projection and recess. The projection and recess may be designed with correspondingly inclined surfaces for achieving a wedging effect during assembly. By arranging the clamping element at an opposite position of the recess and projection and in such a manner that a further wedging movement is achieved, the tightness of the connection may be improved.

According to another embodiment, the first and second component comprises engagement surfaces configured for being in engagement with each other, that the engagement surfaces define an engagement plane and that the clamping device is configured for moving the first and second component in relation to each other along the engagement plane during assembly of the arrangement. Such an arrangement creates conditions for achieving a wedging effect, wherein the tightness of the connection may be improved.

According to a further development of the last-mentioned embodiment, the projection and recess, respectively is positioned at one side of the respective engagement surface and the clamping device is positioned at an opposite side of the engagement surfaces in relation to the projection and recess. Such an arrangement creates further conditions for achieving a wedging effect, wherein the tightness of the connection may be improved.

According to another embodiment, the clamping device comprises a fastening means, which is configured for engagement with at least one of the first and second component, and that the fastening means is movably arranged in relation to the clamping element for achieving clamping of the flange portions via the clamping element during assembly of the arrangement.

The fastening means may be arranged in a correspondingly shaped hole or holes through the clamping element for performing the clamping effect. The fastening means may be configured by one or several fasteners, such as a screw, a pin bolt or similar.

According to a further development of the last-mentioned embodiment, the fastening means is arranged for moving the clamping element in parallel with the engagement plane during assembly of the arrangement. Such an arrangement creates further conditions for achieving a wedging effect, wherein the tightness of the connection may be improved.

According to another embodiment, the one of the first and second component comprising the recess further comprises a projecting portion, which defines the recess as an undercut. This design creates conditions for positioning the free component so that the projection is in engagement with the recess, wherein the weight of the free component may be held by the stationary component, especially in case the contact surface of the second component has a substantial vertical composant. Thus, it would relieve the service technician from holding the weight of the free component during the assembly. Preferably, a multi-step fastening method is used, wherein the free component is first hanged onto the stationary component and then clamped to the stationary component via the clamping device.

According to another embodiment, the recess has an elongated shape and the projection has a correspondingly shaped elongated shape. In this way, the contact regions may be distributed over a relatively long distance, which creates conditions for a reduced leakage risk during operation in case the two components are configured for transporting a gas/fluid. More specifically, the projection may form an elongated wall and such an elongated wall may for example be straight. Further, such an elongated wall may for example have a substantially constant cross section along its longitudinal direction.

According to another embodiment, at least one of the recess and the projection comprises means for directing the first and second component relative to one another in a direction transverse to a main relative movement direction during assembly of the arrangement. By means of such transverse directioning means, a desired relative transverse position of the components may be secured. This is especially important in case the components are adapted for carrying a fluid, such as exhaust gas, from one of the components to the other, and sealing between the components is important.

According to a further development of the last-mentioned embodiment, the transverse directioning means comprises an inwardly tapered opening on one of the first and second component and a transverse directioning member on the other of the first and second component and that the transverse directioning member is configured for being received in the opening and interacting with the side wall of the opening for effecting a relative movement of the first and second component during assembly of the arrangement. This is a cost-effective solution, which creates conditions for a proper alignment. The transverse directioning member may for example be formed by a pin, which is positioned in a bore hole.

According to another embodiment, the recess is open in such a direction allowing the first component first to be hanged onto the second component while the projection being received in the recess and then to be pivoted around an axis at the engagement position of the recess and projection to a position in which the first and second components are in contact at an opposite side of respective engagement surfaces in relation to the projection and recess. This design is particularly advantageous when the engagement plane is substantially vertically oriented. Further, this design creates conditions for positioning the free component so that the projection is in engagement with the recess, wherein the weight of the free component may be held by the stationary component. Thus, it relieves the service technician from holding the weight of the free component during the assembly.

It is desirable to provide a method, which creates conditions for a facilitated and thereby time-efficient mounting of the two internal combustion engine components.

According to another aspect of the invention, a method is provided for fastening a first component to a second component, which are associated to an internal combustion engine, wherein the method comprises the steps of
positioning the first and second components relative to one another so that a projection of one of the first and second component is engaged in a recess of the other of the first and second component,
moving a clamping element of a clamping device in relation to the first and the second component for clamping the first and second components together, and
clamping two flange portions, one from each of the first and second components, via a first and second clamping surface of the clamping element, which clamping surfaces faces each other, for effecting an outside of the respective flange portion for clamping the flange portions between the clamping surfaces.

The proposed method may for example be used for fastening a turbocharger to an exhaust manifold. By providing each of the components with a flange portion and the clamping element so that it engage around both flange portions, preferably substantially simultaneously, the mounting procedure may be significantly facilitated. Further, for example, by configuring the projection and recess properly, the invention creates conditions for performing the tightening of the assembly from only one side, ie from the side of the clamping element while the projection rests in the recess.

According to a preferred embodiment, the method comprises the further step of first hanging the first component onto the second component while the projection being received in the recess, then pivoting the first component around an axis at the engagement position of the recess and projection to a position in which the first and second components are in contact at an opposite side of the engagement surfaces in relation to the projection and recess and then performing the clamping. For interfaces of a substantially vertical direction and relatively heavy components, the possibility to first hang the first component onto the second component relieves the service technician from the burden of the weight of the first component. Further, in the case of a substantially vertically oriented engagement plane, the tightening operation may be performed from above, which for many engines creates conditions for improved access for the service technician.

According to a further preferred embodiment, the method comprises the further step of moving the first and second component in relation to each other along respective engagement planes during the clamping. By performing the relative movement during the tightening itself, the projection may be forced further into the recess, which creates conditions for a tighter fit and thereby less leakage during operation.

According to a preferred embodiment, the method comprises the further step of moving a fastening means in relation to the clamping element for clamping the flange portions via the clamping element during clamping. The fastening means may comprise one or several fasteners, which in turn may be constituted by a screw and nut, pin bolt or similar. By arranging such fastening means for movement of the clamping element relative to the first and second component, it creates further conditions for performing the tightening of the assembly from only one side, ie from the side of the clamping element.

According to a preferred embodiment, the method comprises the further step of moving a fastening means in parallel with the engagement planes during the clamping. It creates further conditions for performing the tightening of the assembly from only one side, ie from the side of the clamping element.

According to a preferred embodiment, the method comprises the further step of directing the first and second component relative to one another in a direction transverse to a main relative movement direction during assembly of the arrangement. In this way, any jamming between the first component and the second component in a non-desired relative transverse position may be avoided. By guiding the first component in the transverse direction during the movement towards its intended position, the correct, desired transverse position may be achieved with good accuracy, wherein the risk of leakage during operation is also reduced.

It is desirable to provide a component, which creates conditions for a facilitated and thereby time-efficient mounting of the two internal combustion engine components.

According to another aspect of the invention, a first component for being fastened to a second component associated to an internal combustion engine is provided. The first component comprises either a recess or a projection configured for being engaged with the second component. The first component comprises a flange portion at a distance from the recessiprojection, which is configured for being effected at an outside thereof by a clamping surface of a clamping device for clamping the first component to the second component. By designing the flange portion so that the clamping device may grip around it in a tight manner, preferably over a substantial part of its length, any bulging of the flange portion during transient heat loads may be avoided. Preferably, the recess/projection is configured for being engaged with a correspondingly shaped projection/recess of the second component. The flange portion preferably has an elongated shape. The flange portion preferably has a substantially straight edge along the longitudinal direction of the flange portion. Further, the recess/projection preferably has an elongated shape and more specifically a substantially straight extension. Preferably, a longitudinal direction of the elongated flange portion is substantially in parallel with a longitudinal direction of the projection/recess. Further, such an elongated shape creates conditions for engagement over a substantial part of its length, wherein any bulging of the projection during transient heat loads may be avoided. In other words, in contrast to some prior solutions where the first component is fastened to the second component in discrete, spaced positions (such as four bolts, one in each corner of a rectangular shaped flange), according to one example, the first component is configured for being clamped in a continuous manner along a substantial part of the length of the flange portion and/or the projection/recess.

According to a preferred embodiment, the first component comprises an engagement surface configured for being in engagement with a correspondingly shaped engagement surface of the second component, wherein the engagement surface defines an engagement plane. Such a design creates conditions for a tight engagement between the components, especially when the components are designed for a relative movement in parallel with the engagement plane during mounting.

According to a further preferred embodiment, the projection or recess is positioned at one side of the engagement surface and the flange portion is positioned at an opposite side of the engagement surface in relation to the projection or recess. Such a design creates further conditions for a tight engagement between the components, especially when the components are designed for a relative movement in parallel with the engagement plane during mounting so that the projection is forced further into the recess.

According to a further preferred embodiment, the flange portion comprises an inclined surface for engagement with a clamping surface of the clamping device. The inclined surface may have such a design that a width of the flange portion is decreasing towards its free end. The inclination may be formed by a gently curved portion.

According to a further preferred embodiment, the first component comprises the projection and that the projection forms a further flange portion. The term “flange portion” comprises for example an elongated wall configured to form a means for attachment to a neighbouring component. Such an elongated wall may for example be straight. Further, such an elongated wall may for example have a substantially constant cross section along its longitudinal direction. The provision of such a flange portion creates conditions for contact pressure over a substantial part of its length, which in turn reduces risk of leakage during operation in case the two components are configured for transporting a gas/fluid. For example, the projection may have a design similar to the flange portion. Further, the external shape of one side of the first component comprising the projection and flange portion may be mirrored in a plane between the projection and flange portion. Thus, according to one example, the external shape of the first component may be symmetrical with regard to such a plane. Hence, the projection and the flange portion may have an identical design.

According to an alternative embodiment, the first component comprises the recess and that it further comprises a projecting portion, which defines the recess as an undercut.

According to a further preferred embodiment, the recess or projection comprises means for directing the first and second component relative to one another in a direction transverse to a main relative movement direction during fastening of the first and second components.

According to a further preferred embodiment, the transverse directioning means comprises an inwardly tapered opening or a transverse directioning member for allowing the transverse directioning member to be received in the opening and interact with the side wall of the opening for effecting a relative movement of the first and second component during fastening of the first and second components. In this way, any jamming between the first component and the second component in a non-desired relative transverse position may be avoided. By guiding the first component in the transverse direction during the movement towards its intended position, the correct, desired transverse position may be achieved with good accuracy, wherein the risk of leakage during operation is also reduced.

According to a further preferred embodiment, the further flange comprises an inwardly tapered opening for receiving transverse directioning member of the second component during assembly of the arrangement for achieving a relative transverse positioning of the first and second components.

According to an alternative embodiment, the recess comprises a transverse directioning member for being received in an inwardly tapered opening of the first component during fastening of the first and second components for achieving a relative transverse positioning of the first and second components.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective view of a boat in the leisure segment provided with three internal combustion engines for propulsion of the boat,

FIG. 2 is a perspective view of an exhaust manifold forming part of a fastening arrangement according to a first embodiment example,

FIG. 3a is a perspective view of a fastening arrangement according to a first embodiment example for fastening a turbocharger to an exhaust manifold of one of the internal combustion engines in FIG. 1,

FIG. 3b is a perspective exploded view of the fastening arrangement according to the first embodiment example shown in FIG. 3a,

FIG. 4 is a perspective view of a turbocharger and an enlarged side view according to a first embodiment example,

FIG. 5 is a cross sectional view of a clamping element in the fastening arrangement according to the first embodiment example,

FIG. 6 is a perspective exploded view of relevant portions of the exhaust manifold and clamping device in the fastening arrangement according to the first embodiment example shown in FIGS. 3a and 3b,

FIG. 7 is a perspective view of an alternative embodiment of the clamping element according to FIG. 6,

FIG. 8-10 show three steps in a fastening method for fastening the turbocharger to the exhaust manifold according to the embodiment of FIG. 3a,

FIG. 11a is a perspective view of a fastening arrangement according to a second embodiment example for fastening a charge air cooler to a casing of one of the internal combustion engines in FIG. 1,

FIG. 11b is a perspective exploded view of the fastening arrangement according to the second embodiment example shown in FIG. 11a,

FIG. 11c is a perspective view of the charge air cooler and an enlarged side view according to the second embodiment example shown in FIG. 11a,

FIG. 12a is a perspective view of a fastening arrangement according to a third embodiment example for fastening a heat exchanger package to a casing of one of the internal combustion engines in FIG. 1,

FIG. 12b is a perspective exploded view of the fastening arrangement according to the third embodiment example shown in FIG. 12a, and

FIG. 12c is a perspective view of the heat exchanger package and an enlarged side view according to the third embodiment example shown in FIG. 12a.

### DETAILED DESCRIPTION

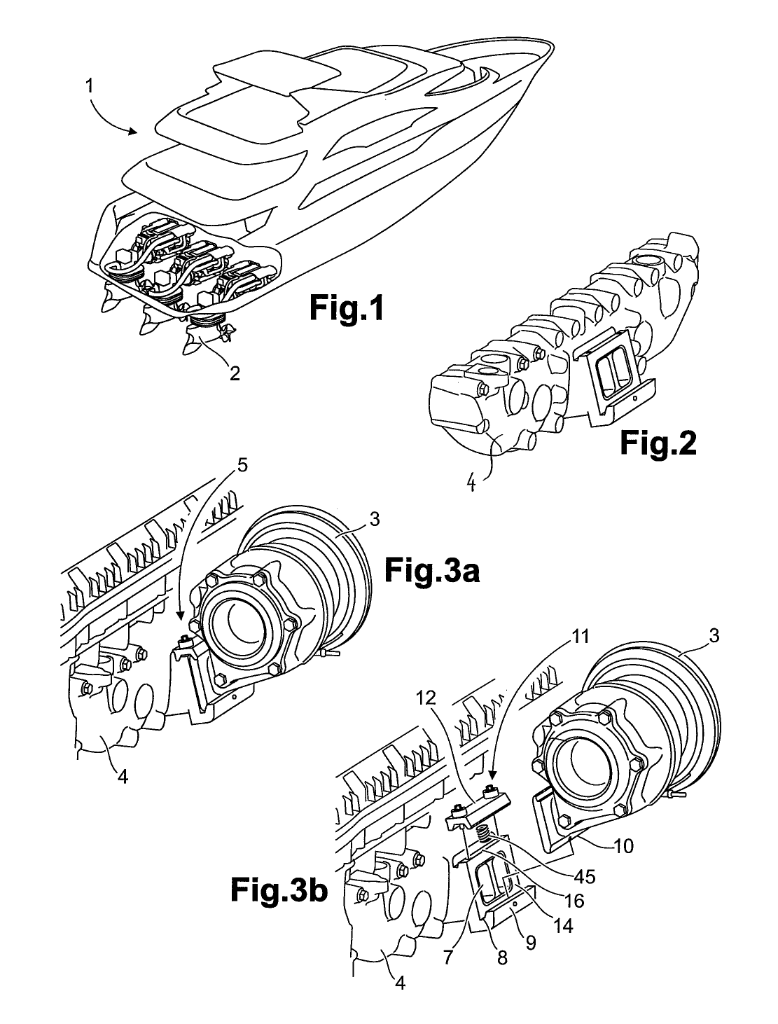

FIG. 1 is a perspective view of a boat 1 in the leisure segment provided with three internal combustion engines 2 arranged in a side-by-side configuration for driving propellers for propelling the boat. Each of the internal combustion engines 2 is a turbocharged diesel engine.

FIG. 3a is a perspective view of a first component 3 in the form of a turbocharger attached to a second component 4 in the form of an exhaust manifold of one of the internal combustion engines 2 in FIG. 1. The exhaust manifold 4 is rigidly attached to an engine casing comprising the cylinders. The exhaust manifold 4 is shown in isolation in FIG. 2. FIGS. 3a-10 show a fastening arrangement 5 for fastening the turbocharger 3 to the exhaust manifold 4, which is stationary since it is attached to the engine casing, and more specifically the interface between the turbocharger 3 and the exhaust manifold 4. The turbocharger 3 comprises a compressor wheel (not shown) for compressing incoming air to the internal combustion engine and a turbine wheel (not shown) rigidly attached to the compressor wheel via a shaft, wherein the turbine wheel is positioned in an exhaust gas flow for rotation. The fastening arrangement 5 will in this embodiment be subjected to extreme heat loads and transients during operation of the engine 2.

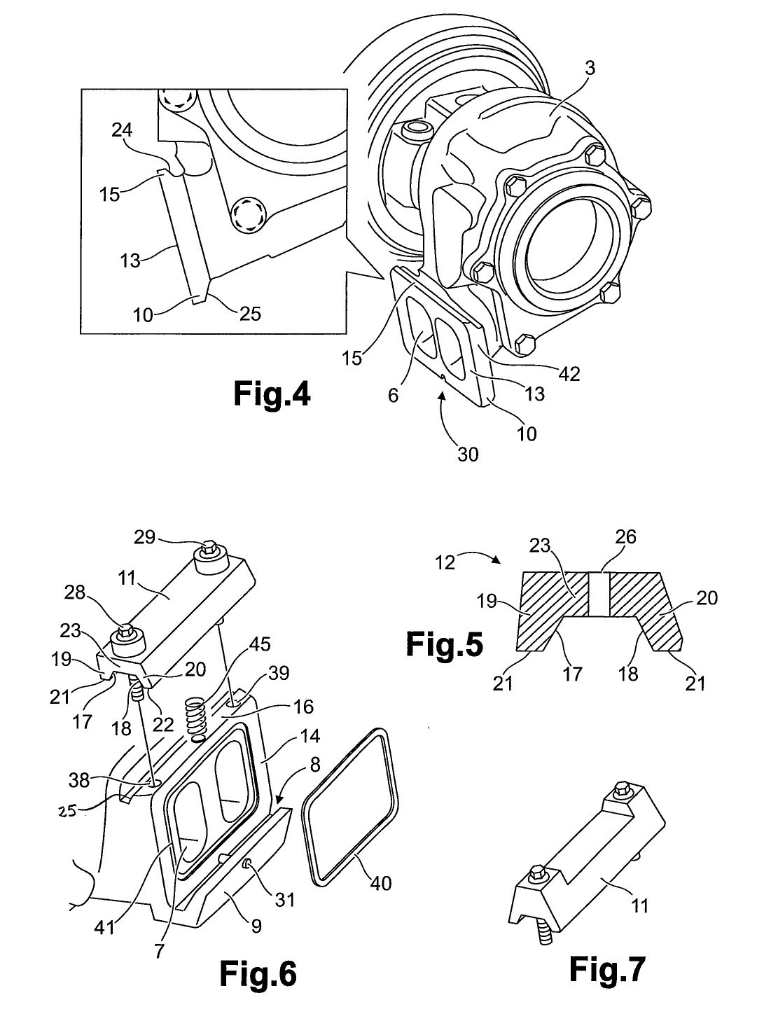

The first component 3 comprises at least one gas channel 6, see FIG. 4, and one end of the gas channel 6 is open in an engagement plane. The gas channel 6 is configured for receiving an exhaust gas from the second component 4 and conveying the exhaust gas to the turbine wheel (not shown). The second component 4 also comprises at least one gas channel 7, see FIG. 3b, and one end of the gas channel 7 is open in an engagement plane. The first and second components 3,4 are fastened to each other in a way that the gas channel ends are in register with each other for conveying the exhaust gas with a minimum of flow disturbance.

FIG. 3b is a perspective exploded view of the fastening arrangement according to the first embodiment example shown in FIG. 3a. The engagement plane is flat and substantially vertically oriented or inclined with a relatively small angle in relation to the vertical direction. The second component 4 comprises a recess 8. The recess 8 has an elongated shape, which extends along a straight line. More specifically, the recess 8 has a substantially horizontal extension direction. The second component 4 further comprises an elongated projecting portion 9, which defines the recess 8 as an undercut. The recess 8 is positioned vertically below the gas channel opening 7. The recess 8 extends at least along the complete transverse distance of the gas channel opening 7. In the shown embodiment example, the recess 8 extends a certain distance at each side of the gas channel opening 7 in the recess longitudinal direction.

The first component 3 comprises a projection 10, which has an elongated shape and is correspondingly shaped relative to the recess 8 for engagement. More specifically, the projection 0 forms a flange portion, which is elongated and has a relatively straight edge.

The recess 8 is open in such a direction allowing the first component 3 first to be hanged onto the second component 4 while the projection 10 being received in the recess 8 and then to be pivoted around an axis at the engagement position of the recess 8 and projection 10 to a position in which the first and second components 3,4 are in contact at an opposite side of respective engagement surfaces in relation to the projection and recess, see further description below referring to FIGS. 7-9.

The first and second component 3,4 comprises engagement surfaces 13,14 configured for being in engagement with each other. More specifically, the engagement surfaces 13,14 define an engagement plane. The projection 10 and recess 8, respectively, is positioned at one side of the respective engagement surface 13,14 and the clamping device 1 is positioned at an opposite side of the engagement surfaces 13,14 in relation to the projection 10 and recess 8. More specifically, the projection 10 and recess 8, respectively, is positioned at a lower side of the respective engagement surface 13,14 and the clamping device 11 is positioned at an upper side of the engagement surfaces 13,14 in relation to the projection 10 and recess 8.

The fastening arrangement 5 comprises the first component 3, the second component 4 and a clamping device 1 for clamping the first and second components 3,4 together. The clamping device 11 comprises a clamping element 12, which is movably arranged in relation to the first and the second component 3,4 when in an engaged state. In other words, when the first component 3 has been positioned relative to the second component 4 so that the projection 10 engages the recess 8 and so that the engagement surfaces are in contact with each other, the clamping element 12 may be moved for clamping the first component 3 to the second component 4.

Each one of the first and second component 3,4 comprises a flange portion 15,16 at a distance from the recess and projection 8,10, respectively. Each one of the flange portions 15,16 of the first and second components comprises an inclined surface 24,25 for engagement with clamping surfaces of the clamping element 1.

The clamping element 11 comprises a first and second clamping surface 17,18 facing each other for effecting an outside of the respective flange portion 15,16 for clamping the flange portions between the clamping surfaces, see FIG. 4. The first and second clamping surfaces 17,18 are inclined in relation to each other. More specifically, the clamping element comprises two spaced walls 19,20, wherein one 19 of the spaced walls comprises the first clamping surface 17 and the other 20 of the spaced walls comprises the second clamping surface 18. The free edges 21,22 of the spaced walls define an entrance for receipt of the flange portions.

The clamping element 11 comprises a wall portion 23 bridging the distance between the two spaced walls 19,20. Thus, the clamping element 11 forms a recess defined by the inner surfaces of the wall portion 23 and the two spaced walls 19,20. The clamping element 11 is elongated and has a constant cross sectional shape along its length. Further, the clamping element 11 is a one-piece unit. The wall portion 23 comprises two through holes 26,27 positioned at a distance from each other in a longitudinal direction of the clamping element 11 and each configured for receipt of a fastener.

More specifically, the first component 3 comprises a flange section 42 at an end of the gas channel 6. The flange section 42 has a rectangular shape and defines the contact surface 13 at its free end. The flange section 42 further comprises the projection 10 in the form of a flange portion defining a lower side of the rectangular flange section 42. The above-mentioned flange portion 15 to be clamped by the clamping element 11 defines an upper side of the rectangular flange section 42. The lower flange portion 10 will be received in the elongated recess 8 along substantially its complete length. Similarly, the upper flange portion 15 will be received in the recess defined in the clamping element 11 along substantially its complete length.

The clamping device 5 comprises a fastening means 28,29, which is configured for engagement with at least one of the first and second component 3,4. The fastening means 28,29 is movably arranged in relation to the clamping element 11 for achieving clamping of the flange portions 15,16 via the clamping element 11 during assembly of the arrangement. More specifically, the fastening means 28,29 is arranged for moving the clamping element 11 in parallel with the engagement plane during assembly of the arrangement. The fastening means 28,29 comprises two fasteners 28,29 in the through holes 26,27 of the clamping element 11. More specifically, the fasteners 28,29 are constituted by screws. Further, two spaced and internally threaded holes 38,39 are provided in the second component 4, which are in register with the two holes 26,27 in the clamping element 11. The internally threaded holes 38,39 has a direction substantially in parallel with the contact surface 14 and the engagement plane 32.

Further, at least one of the recess 8 and the projection 10 comprises means 30,31 for directing the first and second component 3,4 relative to one another in a direction transverse to a main relative movement direction during assembly of the arrangement. This “main relative movement direction” is defined by the plane of the paper in FIGS. 7-9. In other words, the transverse directioning means 30,31 is configured to guide the components to a correct transverse position in parallel with the engagement plane. The transverse directioning means 30,31 comprises an inwardly tapered opening 30 on the first component 3 and a transverse directioning member 31 on the second component 4. The transverse directioning member 31 is configured for being received in the opening 30 and interacting with the side wall of the opening 30 for effecting a relative movement of the first and second component 3,4 during assembly of the arrangement. More specifically, the inwardly tapered opening 30 is positioned substantially centrally in the longitudinal direction of the clamping element 11. The inwardly tapered opening 30 forms a slot with a wide mouth and inclined internal walls for achieving the transverse directing effect. The transverse directioning member 31 is formed by a pin. Preferably, the pin is positioned via first drilling a hole through the projection portion 9 and further into the contact surface 14 at a small distance from a bottom surface of the recess 8 and thereafter, the pin 31 is positioned in the drilled holes.

Further, the fastening arrangement 5 comprises a seal 40. The seal 40 is configured to be received in a seal slot 41 arranged in one of the contact surfaces 14,15 and extending around the gas channel opening 6,7. The seal 40 is continuous and has a substantially rectangular shape with rounded corners.

The fastening arrangement 5 further comprises a spring means 45 for keeping a distance between the clamping element 12 and the second component 4 when the fastening means 28,29 is in a non-fastened state allowing the first component 3 to be positioned in the desired position in contact with the second component 4 before any tightening takes place. In other words, the spring means 45 secures a certain distance between the clamping element 12 and the second component 4 so that the flange 15 can pass below the lower edge 21 of the clamping element 12. The spring means 45 is positioned between opposite surfaces of the clamping element 12 and the second component 4. The spring means 45 is configured to be compressed during tightening of the fastening means 28,29, ie when the clamping element 12 is moved closer to the second component 4.

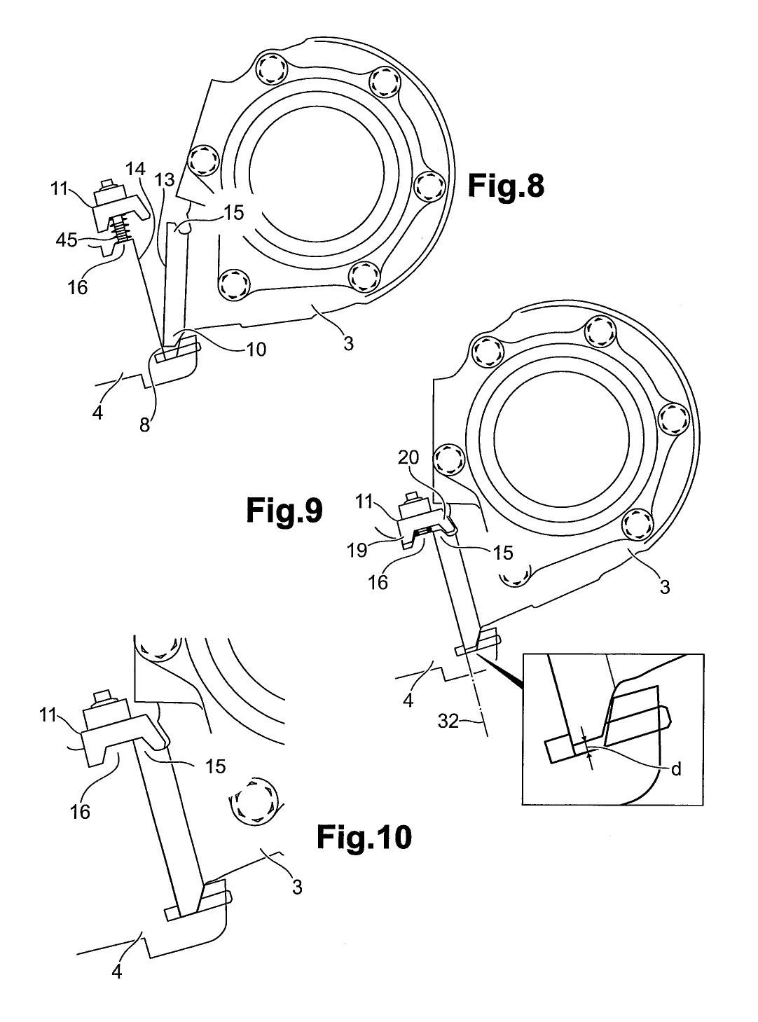

FIGS. 8-10 show three steps in a fastening method for fastening the first component 3 to the second component 4 according to the embodiment of FIG. 3a. In a first step, see FIG. 8, the first component 3 is positioned relative to the second component 4 so that the projection 10 of the first component 3 is engaged in the recess 8 of the second component 4. Further, the first component 3 is positioned relative to the second component 4 with an angle between the plane contact surfaces 13,14. In other words, the first step comprises hanging the first component 3 onto the second component 4 while the projection 10 being received in the recess 8.

In a second step, see FIG. 9, the first component 3 is pivoted around an axis at the engagement position of the recess 8 and projection 10 to a position in which the first and second components 3,4 are in contact at an opposite side of the engagement surfaces 13,14 in relation to the projection. In a third step, see also FIG. 9, the clamping element 11 is moved in relation to the first and the second component 3,4 for clamping the first and second components 3,4 together. Thus, the two flange portions 15,16, one from each of the first and second components 3,4 are clamped, via the first and second clamping surface 17,18 of the clamping element 11. An outside of the respective flange portion 15,16 are contacted by the clamping element 11 for clamping the flange portions between the clamping surfaces. Thus, the wall portions 19, 20 of the clamping element 11 grips around the flanges 15,16 via the inclined surfaces. More specifically, the clamping device 5 is configured for moving the first and second component 3,4 in relation to each other along the engagement plane during assembly of the arrangement.

FIG. 9 further shows an enlarged side view of the engagement region between the projection 10 and the recess 8. The projection 10 and recess 8 are configured so that when the first component 3 has been pivoted to the position shown in FIG. 8 there will still be a certain gap d between a lower surface of the projection 10 and a bottom surface of the recess 8.

Due to the weight of the first component 3 and a relatively narrow fit between the projection 10 and the recess 8, the projection relatively quickly tends to pinch relative to the recess 8. Therefore, the directioning means 30,31 are configured for transversely directing the first component 3 relative to the second component 4 to a correct transverse position before the components are pinched to a state where it would be difficult to correct any transverse misalignment. Thus, simultaneously in the third step, the first and second components 3,4 are directed relative to one another in a direction transverse to a main relative movement direction during assembly of the arrangement via the transverse directioning means 30,31. The above-mentioned “main relative movement direction” comprises both the relative pivoting motion around the pivot axis at the contact point between the projection 10 and the recess 8 and the consecutive relative straight motion in parallel with the engagement plane.

In a fourth step, see FIG. 10, the fastening means 28,29 are moved (fasteners tightened) so that the projection 10 is forced further into the recess 8 during the clamping. Thus, the fastening means 28,29 is moved in parallel with the engagement planes during the clamping. Simultaneously the first and second components 3,4 are directed relative to one another in a direction transverse to a main relative movement direction during assembly of the arrangement via the transverse directioning means 30,31. The gap d in FIG. 9 is here extinguished. Alternatively, there may still be a small gap present after tightening of the fastening means 28,29.

Thus, the clamping device 5 is configured for forcing the projection from an initial engagement position further into the recess during assembly of the arrangement.

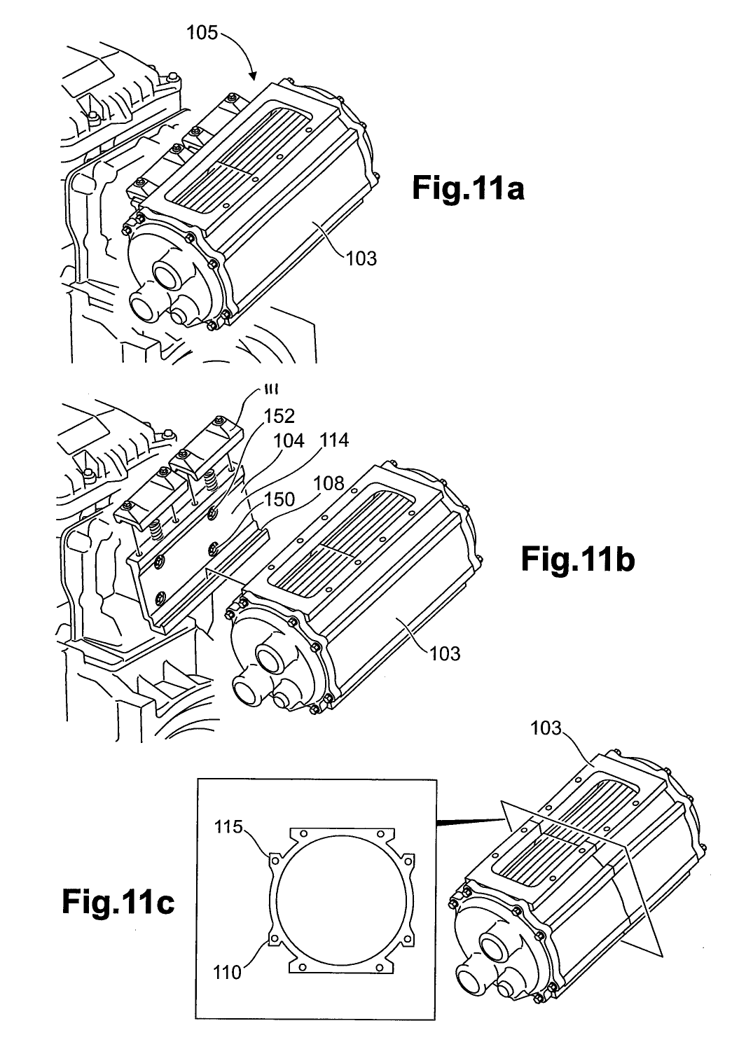

FIG. 1a is a perspective view of a first component 103 in the form of a charge air cooler 103 attached to a second component 104, which in turn is rigidly attached to a casing of one of the internal combustion engines in FIG. 1. The charge air cooler 103 is configured for cooling air compressed by the compressor wheel of the turbocharger 3 during engine operation. More specifically, FIG. 11a shows a fastening arrangement 105 according to a second embodiment example. FIG. 11b is a perspective exploded view of the fastening arrangement according to the second embodiment example shown in FIG. 11a. FIG. 11c is a perspective view of the charge air cooler 103 and an enlarged side view according to the second embodiment example.

The second component 104 is detachably connected to the engine casing via a fastening means 150. The second component 104 forms an intermediate member, which is designed on the one hand for easy mounting to the engine casing and on the other hand for holding the charge air cooler 103 in its position. The second component 104 has a relatively flat shape, wherein a first main surface faces the engine casing and an opposite main surface faces the charge air cooler. The second component 104 comprises a plurality of through holes 152 distributed over the component for receipt of fasteners, especially screws, in the fastening means 150. In similarity to the first embodiment example, the second component 104 comprises an elongated recess 108 for receipt of a correspondingly shaped elongated projection 110 of the charge air cooler. Further, the second component 104 is positioned so that an engagement plane between the charge air cooler 103 and the second component 104 is substantially vertical. The charge air cooler 103 comprises an elongated, straight flange portion 115 for being engaged with the clamping element 111. Since the fastening principle is the same as has been described above with regard to the first embodiment example, it will not be described in detail again.

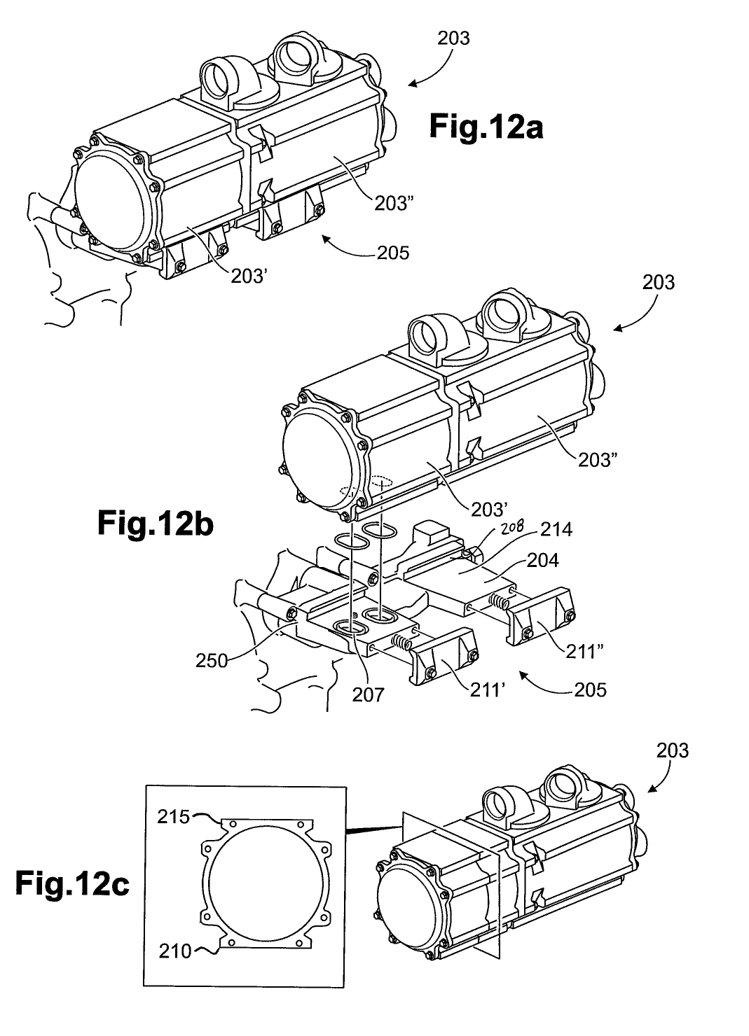

FIG. 12a is a perspective view of a first component 203 in the form of a heat exchanger package 203 attached to a second component 204, which in turn is rigidly attached to a casing of one of the internal combustion engines in FIG. 1 via a fastening arrangement 205 according to a third embodiment example. FIG. 12b is a perspective exploded view of the fastening arrangement 205 according to the third embodiment example shown in FIG. 12a. FIG. 21c is a perspective view of the heat exchanger package and an enlarged side view according to the third embodiment example.

The second component 204 is detachably connected to the engine casing via a fastening means 250. The second component 204 forms an intermediate member, which is designed on the one hand for easy mounting to the engine casing and on the other hand for holding the heat exchanger package 203 in its position. The second component 204 has a relatively flat shape, wherein a first side surface faces the engine casing and a main surface 214 is configured to receive the heat exchanger package 203. The second component 204 is attached to the engine casing so that the contact surface 214 of the second component 204 and also an engagement plane between the heat exchanger package 203 and the second component 204 is substantially horisontal. The fastening means 250 comprises elongated fasteners, in the form of screws, which are provided in through holes of the second component 204 and more specifically directed substantially in parallel with the contact surface 214.

The heat exchanger package 203 comprises at least two heat exchangers 203′ and 203″ rigidly connected to each other in a side-by-side relationship. In the shown embodiment, the first heat exchangers 203′ is constituted by an oil cooler and the second heat exchanger 203″ is constituted by a coolant cooler, such as a glycol-water-cooler. The second component 204 comprises at least one fluid channel, wherein a fluid channel opening 207 is open in the contact surface 214. Each of the heat exchangers 203′ and 203″ in the heat exchanger 203 comprises an elongated, straight projection 210 for being engaged in a correspondingly shaped recess 208 and an elongated, straight flange portion 215 for being engaged with the clamping element 211.

Due to that the heat exchanger package 203 has a relatively long length in the direction of the side-by-side arranged heat exchangers, two clamping elements 21 Γ, 211″ are provided, one for the clamping of each heat exchanger.

Although the contact surface 214 is arranged substantially horizontally instead of the substantially vertical direction in the first and second embodiment examples, the fastening principle is similar. Of course, due to the fact that the contact surface is substantially horizontal, there is no need for the multi-step mounting procedure comprising hanging the first component onto the second component and pivoting etc. Therefore, since the fastening principle is so similar as has been described above with regard to the first embodiment example, it will not be described in detail again.

In the embodiment examples shown in FIGS. 11 and 12, a housing of the first component 103, 203 comprising the projection 110, 210 and the flange portion 110, 210 may be manufactured via extrusion. The external cross sectional shape of the housing, see FIGS. 11c and 12c, is identical in two spaced positions in an extrusion direction. In prior art fastening arrangements for such extruded housings, material normally has to be added in order to withstand processing/working in directions perpendicular relative to the extrusion direction. Due to the inventive fastening arrangement, such processing/working is not necessary and therefore such additions of material are not necessary either. Thus, these embodiment examples create conditions for material savings and a more efficient manufacturing method. The housing may for example be formed by an aluminium alloy.

It is to be understood that the present invention is not limited to the embodiments described above and illustrated in the drawings; rather, the skilled person will recognize that many changes and modifications may be made within the scope of the appended claims.

For example, with regard to the first embodiment example, the first component (which is there constituted by the turbocharger) may be provided with the recess in the form of an undercut in a projecting portion above the engagement surfaces, ie as an upper part. In such a case, the second component (exhaust manifold) may be provided with a correspondingly shaped projection, preferably a flange portion, at an upper side. For such a design, in an application with a substantially vertical engagement plane, the first component may also be hanged onto the second component in a first step, followed by pivoting of the first component to a contact position relative to the second component and in turn followed by a tightening operation. The clamping element will in such a design be positioned below the projection/recess.

1. An internal combustion engine arrangement for fastening a first component to a second component, wherein the fastening arrangement comprises the first component, the second component and a clamping device for clamping the first and second components together, wherein one of the first and second component comprises a recess and the other of the first and second component comprises a projection, wherein the recess and projection are configured for being engaged, wherein the clamping device comprises a clamping element, which is movably arranged in relation to the first and the second component when in an engaged state wherein each one of the first and second component comprises a flange portion at a distance from the recess and projection, respectively, that the clamping element comprises a first and second clamping surface (17, 8) facing each other for effecting an outside of the respective flange portion for clamping the flange portions between the clamping surfaces.

2. An arrangement according to claim 1, wherein the first and second clamping surfaces are inclined in relation to each other.

3. An arrangement according to claim 1, wherein the clamping element comprises two spaced walls, that one of the spaced walls comprises the first clamping surface and the other of the spaced walls comprises the second clamping surface and that the free edges of the spaced walls define an entrance for receipt of the flange portions.

4. An arrangement according to claim 1, wherein the clamping element is a one-piece unit.

5. An arrangement according to claim 1, wherein the clamping device is configured for forcing the projection from an initial engagement position further into the recess during assembly of the arrangement.

6. An arrangement according to claim 1, wherein the first and second component comprises engagement surfaces configured for being in engagement with each other, that the engagement surfaces define an engagement plane and that the clamping device is configured for moving the first and second component in relation to each other along the engagement plane during assembly of the arrangement.

7. An arrangement according to claim 6, wherein the projection and recess, respectively is positioned at one side of the respective engagement surface and that the clamping device is positioned at an opposite side of the engagement surfaces in relation to the projection and recess.

8. An arrangement according to claim 1, wherein the clamping device comprises a fastening means, which is configured for engagement with at least one of the first and second component, and that the fastening means is movably arranged in relation to the clamping element for achieving clamping of the flange portions via the clamping element during assembly of the arrangement.

9. An arrangement according to claim 6, wherein the fastening means is arranged for moving the clamping element in parallel with the engagement plane during assembly of the arrangement, and wherein the clamping device comprises a fastening means which is configured for engagement with at least one of the first and second component, and that the fastening means is movably arranged in relation to the clamping element for achieving clamping of the flange portions via the clamping element during assembly of the arrangement

10. An arrangement according to claim 1, wherein each one of the flange portions of the first and second components comprises an inclined surface for engagement with the clamping surfaces of the clamping element.

11. An arrangement according to claim 1, wherein the one of the first and second component comprising the recess further comprises a projecting portion, which defines the recess as an undercut.

12. An arrangement according to claim 1, wherein the recess has an elongated shape and that the projection has a correspondingly shaped elongated shape.

13. An arrangement according to claim 1, wherein that at least one of the recess and the projection comprises means for directing the first and second component relative to one another in a direction transverse to a main relative movement direction during assembly of the arrangement.

14. An arrangement according to claim 13, wherein that the transverse directioning means comprises an inwardly tapered opening on one of the first and second component and a transverse directioning member on the other of the first and second component and that the transverse directioning member is configured for being received in the opening and interacting with the side wall of the opening for effecting a relative movement of the first and second component during assembly of the arrangement.

15. An arrangement according to claim 1, wherein the recess is open in such a direction allowing the first component first to be hanged onto the second component while the projection being received in the recess and then to be pivoted around an axis at the engagement position of the recess and projection to a position in which the first and second components are in contact at an opposite side of respective engagement surfaces in relation to the projection and recess.

16. An arrangement according to claim 1, wherein the first component is a turbocharger and the second component is an exhaust manifold of the internal combustion engine.

17. An arrangement according to claim 1, wherein the first component is a heat exchanger.

18. A method for fastening a first component to a second component, which are associated to an internal combustion engine, wherein the method comprises the steps of positioning the first and second components relative to one another so that a projection of one of the first and second component is engaged in a recess of the other of the first and second component, and moving a clamping element of a clamping device in relation to the first and the second component for clamping the first and second components together comprising the steps of clamping two flange portions, one from each of the first and second components, via a first and second clamping surface of the clamping element, which clamping surfaces faces each other, for effecting an outside of the respective flange portion for clamping the flange portions between the clamping surfaces.

19. A method according to claim 18, comprising the further step of first hanging the first component onto the second component while the projection being received in the recess, then pivoting the first component around an axis at the engagement position of the recess and projection to a position in which the first and second components are in contact at an opposite side of the engagement surfaces in relation to the projection and recess and then performing the clamping.

20. A method according to claim 18, comprising the further step of moving the first and second component in relation to each other along respective engagement planes during the clamping.

21. A method according to claim 18, comprising the further step of forcing the projection further into the recess during the clamping.

22. A method according to claim 18, comprising the further step of moving a fastening means in relation to the clamping element for clamping the flange portions via the clamping element during clamping.

23. A method according to claim 18, comprising the further step of moving a fastening means in parallel with the engagement planes during the clamping.

24. A method according to claim 18, comprising the further step of directing the first and second component relative to one another in a direction transverse to a main relative movement direction during assembly of the arrangement.

25. A first component for being fastened to a second component associated to an internal combustion engine, wherein the first component comprises either a recess or a projection 440 configured for being engaged with the second component wherein the first component comprises a flange portion at a distance from the recess/projection, which is configured for being effected at an outside thereof by a clamping surface of a clamping device for clamping the first component to the second component.

26. A first component according to claim 25, wherein the first component comprises an engagement surface configured for being in engagement with a correspondingly shaped engagement surface of the second component, that the engagement surface defines an engagement plane.

27. A first component according to claim 26, wherein the projection or recess is positioned at one side of the engagement surface and that the flange portion is positioned at an opposite side of the engagement surface in relation to the projection or recess.

28. A first component according to claim 26, wherein the first component comprises a gas channel and that one end of the gas channel is open in the engagement plane.

29. A first component according to claim 25, wherein the flange portion comprises an inclined surface (24) for engagement with a clamping surface of the clamping device.

30. A first component according to claim 25, wherein the first component comprises the projection and that the projection forms a further flange portion.

31. A first component according to claim 30, wherein the further flange portion comprises an inclined surface for engagement with the recess.

32. A first component according to claim 25, wherein the first component comprises the recess and that it further comprises a projecting portion, which defines the recess as an undercut.

33. A first component according to claim 25, wherein the recess or projection comprises means for directing the first and second component relative to one another in a direction transverse to a main relative movement direction during fastening of the first and second components.

34. A first component according to claim 33, wherein that the transverse directioning means comprises an inwardly tapered opening or a transverse directioning member for allowing the transverse directioning member to be received in the opening and interact with the side wall of the opening for effecting a relative movement of the first and second component during fastening of the first and second components.

35. A first component according to claim 30, wherein that the further flange portion comprises an inwardly tapered opening for receiving a transverse directioning member of the second component during assembly of the arrangement for achieving a relative transverse positioning of the first and second components.

36. A first component according to claim 32, wherein that the recess comprises a transverse directioning member for being received in an inwardly tapered opening of the first component during fastening of the first and second components for achieving a relative transverse positioning of the first and second components.

37. A first component according to claim 25, wherein the flange portion has an elongated shape and that the recess/projection has an elongated shape.

38. A first component according to claim 25, wherein the first component is a turbocharger.

39. A first component according to claim 25, wherein the first component is a heat exchanger.

40. A first component according to claim 25, wherein the first component is an exhaust manifold.

41. An internal combustion engine comprising a fastening arrangement according to claim 1.

42. A vehicle or vessel comprising an internal combustion engine according to claim 41.
